(19) United States
(12) Patent Application Publication
(10) Pub. No.: US 2006/0104501 A1
(43) Pub. Date: May 18, 2006

(54) System and method for calculating a composite position of holes in a workpiece

(75) Inventors: Li Jiang, Shenzhen (CN); Chih-Kuang Chang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 11/273,814

(22) Filed: Nov. 14, 2005

(30) Foreign Application Priority Data
Nov. 12, 2004 (TW) 93134593

(51) Int. Cl. G06K 9/00

(52) U.S. Cl. 382/152

(57) ABSTRACT

The present invention relates to a system for calculating a composite position of holes in a workpiece. The system includes a plurality of user computers (10), an application server (12), a database (14), and a plurality of measure machines (15). Each user computer provides an interactive interface for dynamically displaying operating status. The application server is for importing measure data and theoretical values of the holes in a coordinates system, receiving parameters needed for calculating the composite position, and calculating the composite position. The database is for storing data used or generated during calculating the composite position. The measure machines are for obtaining the measure data of the holes from the workpiece and storing the measure data in the database. A related method is also disclosed.

### BACKGROUND OF THE INVENTION

1. Field of the Invention

The present invention is generally related to a system and method for calculating positions, and more particularly, is related to a system and method for calculating a composite position of holes in a workpiece.

2. General Background

A single position is a particular position of a hole in a workpiece, and a composite position is a relative position of a plurality of holes in a workpiece. Generally, when a single position of each hole and a composite position of all holes in a workpiece both accord with design standards, it means the holes in the workpiece are designed reasonably. Conventionally, calculating of the single position and the composite position is done manually. This not only wastes time but also costs too much.

In a particular example, what is needed is a system for calculating a composite position of holes in a workpiece, which can calculate the composite position easily by a computing device.

Similarly, what is needed is a method for calculating a composite position of holes in a workpiece, which can calculate the composite position easily by a computing device.

### SUMMARY

One embodiment of the present invention provides a system for calculating a composite position of holes in a workpiece as described herein. The system includes: a plurality of customer computers, each of which provides an interactive interface for dynamically displaying operating status; a database for storing data used or generated during the process of calculating the composite position; an application server for importing measure data and theoretical values of the holes in a coordinates system, receiving parameters needed for calculating the composite position, and calculating the composite position; and a plurality of measure machines for obtaining the measure data of the holes from the workpiece and storing the measure data in the database.

The application sever includes a data importing module, a format determining module, an error reminding module, a parameter receiving module, a position calculating module, and a result displaying module.

The data importing module is for importing the measure data and corresponding theoretical values of the holes in a coordinates system from the database. The format determining module is for comparing the measure data with corresponding format standards stored in the database, and determining whether the measure data are coincident with the format standards. The error reminding module is for popping up a dialog box to remind users of corresponding format errors. The parameter receiving module is for receiving parameters needed for calculating the composite position of the holes. The position calculating module can calculate a single position of each hole and a composite position of all the holes based on the imported measure data and the theoretical values. The result displaying module is for displaying the calculated composite position.

Another embodiment of the present invention provides a method for calculating a composite position of holes in a workpiece. The method comprises the steps of: (a) importing measure data and corresponding theoretical values of the holes in a coordinates system from a database; (b) determining whether the measure data are coincident with corresponding format standards stored in the database; (c) receiving parameters needed for calculating the composite position, if the measure data are coincident with format standards; (d) calculating a single position for each hole based on the measure data and the theoretical values of the holes; (e) rotating the coordinates system, and calculating a single position for each hole according to coordinates values of the hole after the rotation; (f) calculating the composite position of all the holes; (g) displaying the calculated composite position.

Other objects, advantages and novel features of the embodiments will be drawn from the following detailed description together with the attached drawings, in which:

### BRIEF DESCRIPTION OF THE DRAWINGS

FIG. 1 is a schematic diagram of hardware configuration and an application environment of a system for calculating a composite position of holes in a workpiece in accordance with a preferred embodiment of the present invention;

FIG. 2 is a schematic diagram of main function modules of an application sever of the system of FIG. 1; and

FIG. 3 is a flow chart of a preferred method for calculating a composite position of holes in a workpiece by utilizing the system of FIG. 1.

### DETAILED DESCRIPTION OF THE PREFERRED EMBODIMENTS

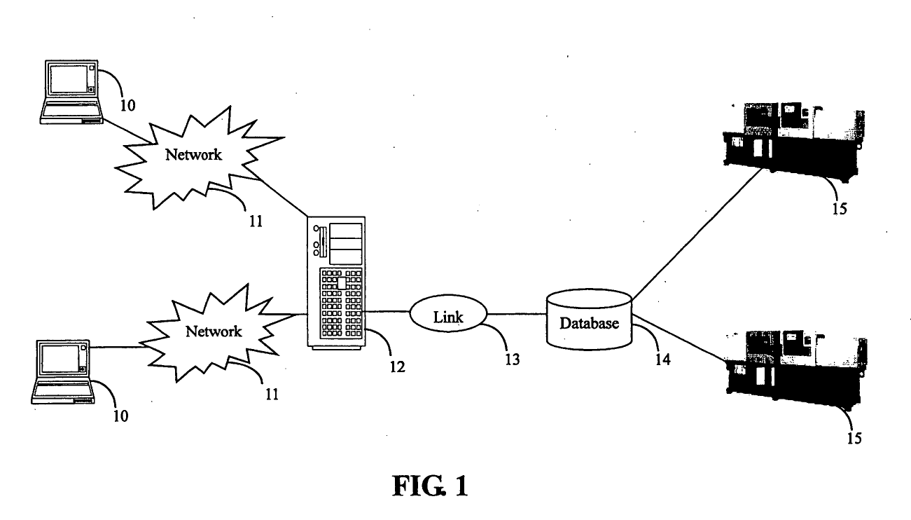

FIG. 1 is a schematic diagram of hardware configuration and an application environment of a system for calculating a composite position of predetermined structures like holes in a workpiece (hereinafter, “the system”) in accordance with a preferred embodiment of the present invention. The system includes a plurality of customer computers 10 (only two shown). Each customer computer provides an interactive interface for dynamically displaying operating status. The customer computers 10 can be desktop computers, laptop computers, or Notebook computers. The customer computers 10 are connected with an application server 12 via a network 11. The network 11 can be an intranet, the Internet, or any other suitable type of communication network. The application server 12 is typically a server computer having several function modules installed therein, for importing measure data and theoretical values of the holes in a coordinates system, receiving parameters needed for calculating the composite position, and calculating the composite position. The application server 12 is connected with a database 14 through a link 13. The link 13 may be an open database connectivity (ODBC), or a Java database connectivity (JDBC).

The database 14 may be any database suitable for storing data used or generated during the process of calculating the composite position. Such data may include the measure data and theoretical values of the holes, format standards, and tolerance ranges. Each theoretical value includes a position value of a corresponding hole in the workpiece, and coordinates of the hole in the coordinates system. The database 14 is connected with a plurality of measure machines 15 (only two shown). The measure machines 15 are for obtaining the measure data of the holes from the workpiece and storing the measure data in the database 14.

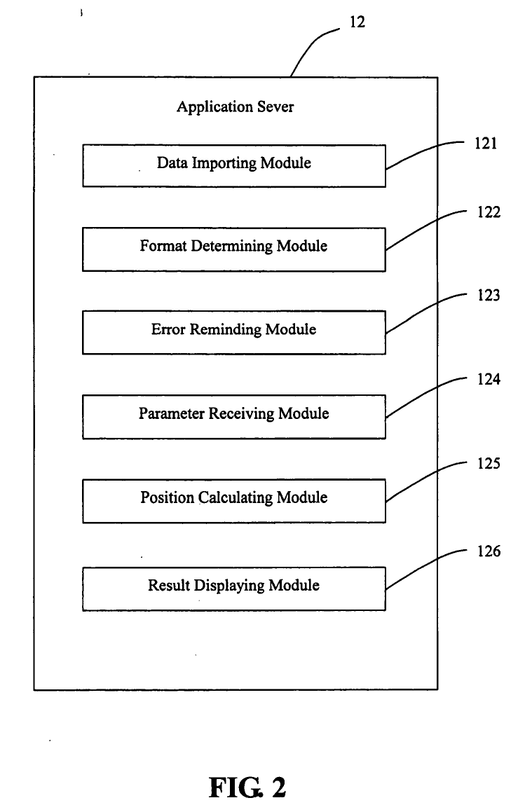

FIG. 2 is a schematic diagram of main function modules of the application sever 12. The application sever 12 includes a data importing module 121, a format determining module 122, an error reminding module 123, a parameter receiving module 124, a position calculating module 125, and a result displaying module 126.

The data importing module 121 imports the measure data and corresponding theoretical values of the holes in a coordinates system from the database 14. Each group of measure data has a specific serial number, and corresponds to the theoretical values which have the same serial number as the measure data. Therefore, when the measure data are imported, the corresponding theoretical values are also obtained according to the serial number of the measure data. The format determining module 122 can compare the measure data with corresponding format standards stored in the database 14, and determine whether the imported measure data are coincident with the format standards. Format errors may include unit errors and data imperfection. The error reminding module 123 is for popping up a dialog box for reminding users of corresponding format errors. The parameter receiving module 124 is for receiving particular parameters needed for calculating the composite position of the holes. The parameters may include choosing a coordinates system and determining tolerance standards.

The position calculating module 125 can calculate a single position of each hole and a composite position of all the holes based on the imported measure data and the theoretical values. Each single position is calculated by the formula as below:
D_{f}={(X′−X)²+(Y′−Y)²}^{1/2 b ×2}
wherein: D_{f} is a single position of a hole in the current coordinates system; X′ and Y′ are measured coordinates values of the hole center in the current coordinates system; and X and Y are theoretical coordinates values corresponding to X′ and Y′. In order to ensure that an offset of each hole is within a specific tolerance range, the coordinates system needs to be rotated by an angle. For example, if a workpiece has two holes, and each single position of the two holes has been calculated. In order to ensure that an offset of each hole is within a specific tolerance range, the coordinates system needs to be rotated by an angle which equals to an angle between the X-axis of the current coordinates system and a line through centers of the two holes. Therefore, the line through the centers of the two holes becomes an X-axis in a new coordinates system after the rotation. Coordinates values of a hole center after the rotation can be calculated by the formula as below:
X₁=X₁₁ cos Q+Y₁₁ sin Q,
Y₁=Y₁₁ cos Q−X₁₁ sin Q,
wherein: X₁₁ and Y₁₁ are coordinates values of the hole center in the previous coordinates system, which equals to X′ and Y′ respectively; and Q is an angle between the current coordinates system and the previous coordinates system. Therefore, the single position of the hole after the rotation can be calculated by substituting X₁ and Y₁ for X′ and Y′ in the formula described above. It should be noted that if a position of each hole in a workpiece accords with design standards, it doesn't mean that relative positions of the holes in the workpiece accord with design standards. In order to ensure relative positions of the plurality of holes in the workpiece also accord with design standards, a composite position of the holes in the workpiece needs to be calculated. By drawing all the hole centers in the new coordinates system and constructing a minimum circle which contains all the hole centers, a diameter of the circle is obtained, which equals to the composite position of all the holes. The result displaying module 126 is for displaying the calculated composite position.

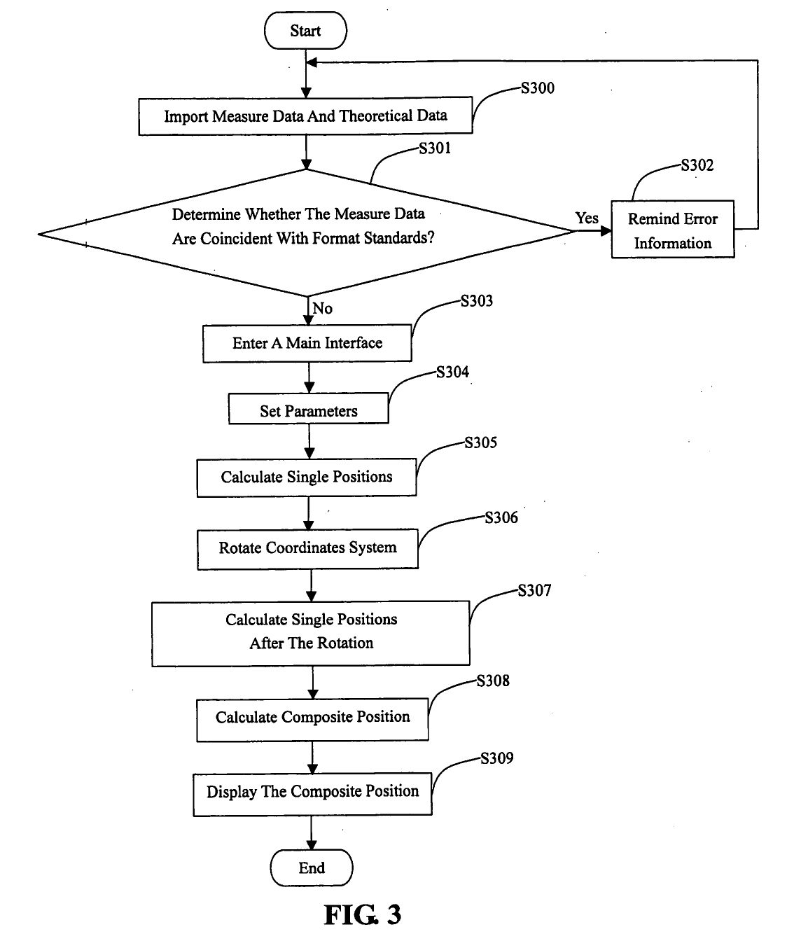

FIG. 3 is a flow chart of a preferred method for calculating a composite position of holes in a workpiece by utilizing the system of FIG. 1. In step S300, the data importing module 121 imports measure data and theoretical values of the holes from the database 14. In step S301, the format determining module 122 compares the measure data with corresponding format standards in the database 14, in order to determine whether the measure data are coincident with the format standards. If the measure data are not coincident with the format standards, in step 302, the error reminding module 123 pops up a dialog box to remind users of corresponding format errors, and the procedure returns to step S300 described above. If the measure data are coincident with the format standards, in step S303, the system enters a main interface. In step S304, the parameter receiving module 124 receives particular parameters needed for calculating the composite position. In step S305, the position calculating module 125 calculates a single position for each hole based on the imported measure data and the theoretical values of the hole. In step S306, the position calculating module 125 rotates the coordinates system in order to calculate the composite position. In step S307, the position calculating module 125 calculates a single position for each hole according to coordinate values of the hole after the rotation. In step S308, the position calculating module 125 calculates the composite position of all the holes. In step S309, the result displaying module 126 displays the calculated composite position.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

We claim:

1. A system for calculating a composite position of holes in a workpiece, the system comprising an application server, the application server comprising:
a data importing module for importing measure data and corresponding theoretical values of the holes in a coordinates system from a database;
a format determining module for comparing the measure data with corresponding format standards stored in the database and determining whether the measure data are coincident with the format standards;
a parameter receiving module for receiving parameters needed for calculating the composite position;
a position calculating module for calculating a single position for each hole and the composite position of all the holes based on the measure data and the theoretical values.

2. The system according to claim 1, wherein the application server further comprises an error reminding module for reminding corresponding format errors.

3. The system according to claim 1, wherein the application server further comprises a result displaying module for displaying the composite position.

4. A computer-based method for calculating a composite position of holes in a workpiece, the method comprising the steps of:
importing measure data and corresponding theoretical values of the holes in a coordinates system from a database;
determining whether the measure data are coincident with corresponding format standards stored in the database;
receiving parameters needed for calculating the composite position, if the measure data are coincident with the format standards;
calculating a single position for each hole based on the measure data and the theoretical values of the hole;
rotating the coordinates system, and calculating a single position for each hole according to coordinates values of the hole after the rotation; and
calculating the composite position of all the holes.

5. The method according to claim 4, wherein the single position for each hole is calculated by the formula:
D_{f}={(X′−X)²+(Y′−Y)²}^{1/2}×2,
wherein D_{f} is the single position of the hole in the coordinates system; X′ and Y′ are measured coordinates values of the hole center in the coordinates system; and X and Y are theoretical coordinates values corresponding to X′ and Y′.

6. The method according to claim 5, wherein the coordinates values of the hole after the rotation is calculated by the formula:
X₁=X₁₁ cos Q+Y₁₁ sin Q,
Y₁=Y₁₁ cos Q+X₁₁ sin Q,
wherein X₁₁ and Y₁₁ are coordinates values of the hole center in the previous coordinates system, which equals to X′ and Y′ respectively; and Q is an angle between the current coordinates system and the previous coordinates system.

7. The method according to claim 4, wherein the step of calculating the composite position of all the holes comprising:
drawing all the hole centers after the rotation in a new coordinates system;
constructing a minimum circle which contains all the hole centers; and
obtaining a diameter of the circle, which equals to the composite position of all the holes.

8. The method according to claim 4, further comprising the step of reminding corresponding format errors, if the measure data are not coincident with the format standards.

9. The method according to claim 4, further comprising the step of displaying the calculated composite position.

10. A method for calculating data of predetermined structures in a workpiece, the method comprising the steps of:
retrieving measure data of predetermined structures in a workpiece referring to a first coordinate system;
retrieving corresponding theoretical data of said predetermined structures to said measure data thereof in said workpiece;
calculating a single type of data for each of said predetermined structures according to said measure data and said corresponding theoretical data of said each of said predetermined structures;
recalculating said single type of data for said each of said predetermined structures referring to a second coordinate system different from said first coordinate system after shifting of said first coordinate system to said second coordinate system when said single type of data in said first coordinate system is unsatisfied; and
calculating a composite type of data for all of said predetermined structures referring to said second coordinate system.

11. The method according to claim 10, wherein said shifting of said first coordinate system to said second coordinate system is rotating of said first coordinate system by an angle.
